(19) United States
(12) Patent Application Publication
(10) Pub. No.: US 2026/0188092 A1
(43) Pub. Date: Jul. 2, 2026

(54) COLLECTING AND SHARING NON-ACTIONABLE INFORMATION AT A FIRST TRANSIT LOCATION SOURCE HUB WITH A SECOND TRANSIT LOCATION DESTINATION HUB

(71) Applicant: MOTOROLA SOLUTIONS, INC., Chicago, IL (US)

(72) Inventors: Eric C. Ittner, Downers Grove, IL (US); Phillips Lohr, Geneva, IL (US); Michal Truszkowski, Schaumburg, IL (US)

(21) Appl. No.: 19/005,681

(22) Filed: Dec. 30, 2024

(51) Int. Cl. G08B 13/196; G06Q 50/26; G06Q 50/40; G06V 20/52; G06V 40/10

(52) U.S. Cl. CPC G08B 13/19647; G06V 20/52; G06V 40/10; G06Q 50/265; G06Q 50/40

(57) ABSTRACT

A method for collecting and sharing non-actionable information at a first transit location source hub with a second transit location destination hub. In one example, the method includes identifying, a first person in an image captured by a first camera included in a first surveillance system at the first transit location source hub, wherein the first person has a threat assessment. The method also includes, in response to the threat assessment being above 0 and below a first minimum threshold, identifying the second transit location destination hub to which the first person is expected to travel to via a common carrier vehicle, packaging, into a first container, first information identifying the first person and the threat assessment, and sending the first container to a second surveillance system at the second transit location destination hub via a communication network.

### BACKGROUND

As a person of interest or object of interest moves about or interacts with a location (for example, a mall, an airport, a train station, or the like), the person or object may be monitored. When it is determined that the person or object of interest poses a credible threat, security personnel at the location may intervene.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments, examples, aspects, and features of concepts that include the claimed subject matter, and to explain various principles and advantages of those embodiments, examples, aspects, and features.

FIG. 1 is an example system for collecting and sharing non-actionable information at a first transit location source hub with a second transit location destination hub.

FIG. 2 is an example block diagram of a first surveillance system at a first transit location source hub.

FIG. 3 is a block diagram of an example first computer included in the first surveillance system of FIG. 2.

FIG. 4 is an example method for collecting and sharing non-actionable information at a first transit location source hub with a second transit location destination hub.

FIG. 5 is an example of first information associated with a first person.

FIG. 6 is an example method for prioritizing data by sending containers via a communication network in an order based on priority and modifying the first information included in the first container.

FIG. 7 is an example of information regarding persons and/or objects of interest traveling on a common carrier.

Skilled artisans will appreciate that elements in the figures are illustrated for simplicity and clarity and have not necessarily been drawn to scale. For example, the dimensions of some of the elements in the figures may be exaggerated relative to other elements to help improve understanding of the examples, aspects, and features presented in this disclosure.

The system, apparatus, and method components have been represented where appropriate by conventional symbols in the drawings, showing only those specific details that are pertinent to understanding of the various embodiments, examples, aspects, and features of the present disclosure so as not to obscure the disclosure with details that will be readily apparent to those of ordinary skill in the art having the benefit of the description herein.

### DETAILED DESCRIPTION OF THE INVENTION

As described above, a person or an object of interest (for example, an object in control of the person of interest) may be monitored when the person or object of interest is at a first location (for example, an airport, a train station, a subway station, or the like). When a threat assessment associated with the person or object of interest reaches a threshold, security personnel at the location may engage the person or object of interest. However, when the threat assessment associated with the person or object of interest is above 0 but below the threshold required for security personnel to engage (or when the threat assessment is above the threshold required for security personnel to engage but security personnel do not engage) and the person travels to a second location via a private carrier or a common carrier(for example, a plane, a train, a bus, a boat, or the like), security personnel at the second location may be unaware of the threat assessment associated with the person or object of interest.

For example, a bystander at an airport terminal may report a suspicious person (a person of interest) who is acting aggressive toward a female traveler and security personnel may decide to continue to monitor the suspicious person through video surveillance. If, however, no additional incidents occur regarding the suspicious person, security personnel may not see a need to act before the person of interest boards a plane. If, however, continued monitoring is not available, when the suspicious person arrives at a destination airport or is traveling on the plane, and further aggressive behavior is exhibited by the suspicious person or egregious acts performed by the suspicious person, that behavior or those acts may either go unnoticed or be written off as a one-time or single occurrence incident even though there is evidence of a pattern of behavior.

While the threat assessment determined for the person or object of interest may be non-actionable at the first location, the threat assessment and information relevant to the threat assessment and person or object of interest may be useful to security personnel at the second location. Information from the first location regarding persons or objects of interest may aid security personnel at the second location identify and address threats more quickly.

One challenge to sharing information regarding persons and objects of interest between locations (for example, sharing information from a first transit location source hub with a second transit location destination hub), is transmitting the most relevant information when network transmission bandwidth for transmitting data between locations is limited. Thus, there exists a need for an improved technical method and system for collecting and sharing non-actionable information at a first transit location source hub with a second transit location destination hub.

One example provides, a system for collecting and sharing non-actionable information at a first transit location source hub with a second transit location destination hub. The system includes a first surveillance system at the first transit location source hub. The first surveillance system includes a first camera and a first computer. The first computer includes a first electronic processor. The first electronic processor is programmed to identify, a first person, or a first object of interest within control of the first person, in an image captured by the first camera, wherein the first person or the first object have a threat assessment. The first electronic processor is also configured to, in response to the threat assessment being above 0 and below a first minimum threshold to trigger a first responsive action to be taken at the first transit location source hub, identify, by accessing an electronic transit travel information database, the second transit location destination hub to which the first person is expected to travel to via a common carrier vehicle, package, into a first container, first information identifying the first person or first object and the threat assessment, and send the first container to a second surveillance system at the second transit location destination hub via a communication network.

Another example provides, a method for collecting and sharing non-actionable information at a first transit location source hub with a second transit location destination hub. The method includes identifying, a first person, or a first object of interest within control of the first person, in an image captured by a first camera included in a first surveillance system at the first transit location source hub, wherein the first person or the first object have a threat assessment. In one example, the method also includes, in response to the threat assessment being above 0 and below a first minimum threshold to trigger a first responsive action to be taken at the first transit location source hub, identifying, by accessing an electronic transit travel information database, the second transit location destination hub to which the first person is expected to travel to via a common carrier vehicle, packaging, into a first container, first information identifying the first person or first object and the threat assessment, and sending the first container to a second surveillance system at the second transit location destination hub via a communication network. In another example, the threat assessment is above 1 and below a first ultimate minimum threshold of 15 on a scale of 100 to trigger a first responsive action. In another example, the threat assessment is a value between 10 and 15 on a scale of 100 to trigger a first responsive action.

Each of the above-mentioned examples will be discussed in more detail below, starting with example system and device architectures of the system in which the example s may be practiced, followed by an illustration of processing blocks for achieving an improved technical method, device, and system for collecting and sharing non-actionable information at a first transit location source hub with a second transit location destination hub.

Examples are herein described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some aspects, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any example, feature, aspect, or embodiment discussed in this specification can be implemented or combined with any part of any other example, feature, aspect, or embodiment discussed in this specification.

Further advantages and features consistent with this disclosure will be set forth in the following detailed description, with reference to the figures.

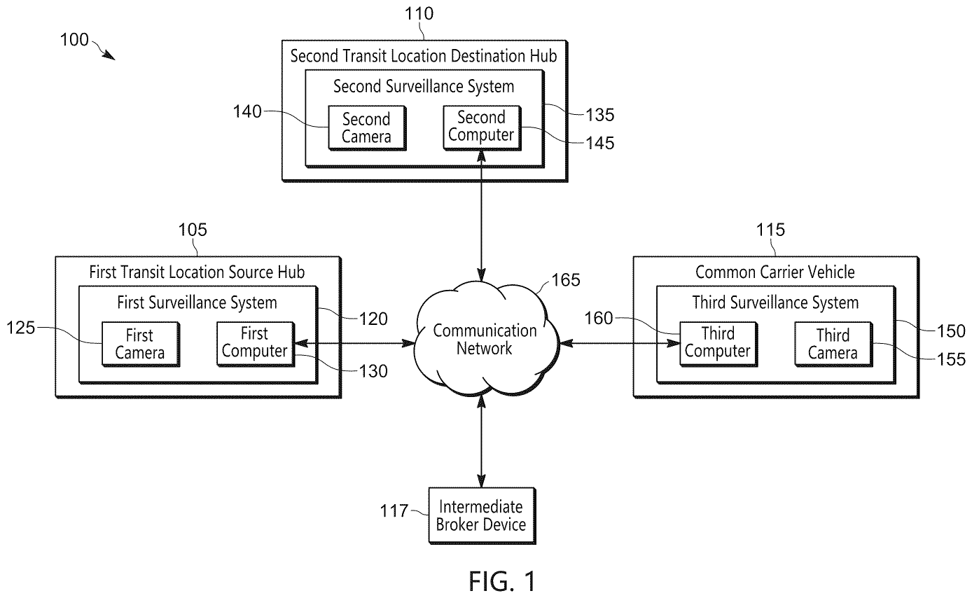

Referring now to the drawings, FIG. 1 illustrates an example system 100 for collecting and sharing non-actionable information at a first transit location source hub with a second transit location destination hub. In some implementations, the system 100 includes a first transit location source hub 105, a second transit location destination hub 110, a common carrier vehicle 115, and an intermediate broker device 117. The first transit location source hub 105 includes a first surveillance system 120. The first surveillance system 120 includes a first camera 125 and a first computer 130. The second transit location destination hub 110 includes a second surveillance system 135. The second surveillance system 135 includes a second camera 140 and a second computer 145. The common carrier vehicle 115 includes a third surveillance system 150. The third surveillance system 150 includes a third camera 155 and a third computer 160. In some implementations, the first computer 130, the second computer 145, and the third computer 160 communicate via the communication network 165. While the surveillance systems 120, 135, and 150 are each illustrated in FIG. 1 as including a single camera and a single computer, one or more of the surveillance systems 120, 135, and 150 may include multiple computers and/or multiple cameras. In some implementations, the intermediate broker device 117 is configured to authenticate and transmit containers of packaged information (for example, the first container described below) when containers are transmitted between disparate security sites or systems under the control of separate entities. For example, when a container is transmitted from the first surveillance system 120 at the first transit location source hub 105 to the second surveillance system 135 at the second transit location destination hub 110 and the first surveillance system 120 and the second surveillance system 135 are under the control of different entities, the container may be sent to the intermediate broker device 117 where the container is authenticated prior to being sent to the second transit location destination hub 110.

The communication network 165 may be implemented using wired or wireless

communication components and may include various networks, for example, a wide area network, such as the Internet, a Long Term Evolution (LTE) network, a Global System for Mobile Communications (or Groupe Spécial Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, a local area network (for example a Wi-Fi™ network or an Ethernet network), and combinations or derivatives thereof.

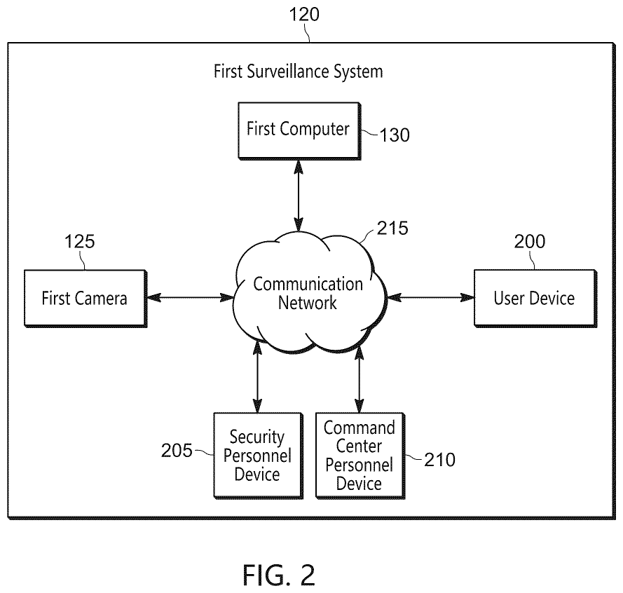

FIG. 2 provides an example block diagram of the first surveillance system 120. In the example illustrated, the first surveillance system 120 includes a first camera 125, a first computer 130, a user device 200, a security personnel device 205, and a command center personnel device 210. In some implementations, the first camera 125, the first computer 130, the user device 200, the security personnel device 205, and the command center personnel device 210 communicate via the communication network 215. The communication network 215 may be implemented using wired or wireless communication components and may include various networks, for example, a wide area network, such as the Internet, a Long Term Evolution (LTE) network, a Global System for Mobile Communications (or Groupe Spécial Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, a local area network (for example, a Wi-Fi™ network or an Ethernet network), and combinations or derivatives thereof.

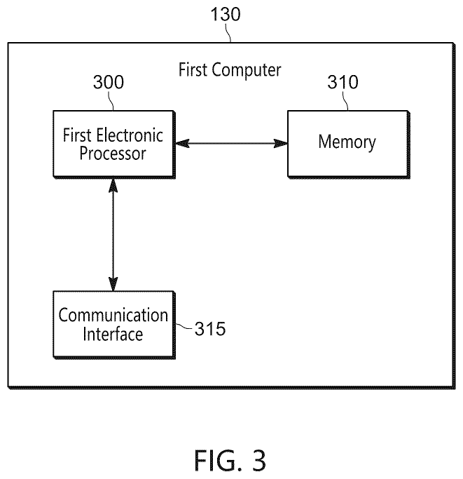

FIG. 3 provides a block diagram of an example first computer 130. In the example provided, the first computer 130 includes a first electronic processor 300, a memory 310, and a communication interface 315. The illustrated components, along with other various modules and components (not shown) are coupled to each other by or through one or more control or data buses that enable communication therebetween. The use of control and data buses for the interconnection between and exchange of information among the various modules and components would be apparent to a person skilled in the art in view of the description provided herein.

The first electronic processor 300 obtains and provides information (for example, from the memory 310, and/or the communication interface 315), and processes the information by executing one or more software instructions or modules, capable of being stored, for example, in a random access memory (“RAM”) area of the memory 310 or a read only memory (“ROM”) of the memory 310 or another non-transitory computer readable medium (not shown). The software can include firmware, one or more applications, program data, filters, rules, one or more program modules, and other executable instructions. The first electronic processor 300 is configured to retrieve from the memory 310 and execute, among other things, software related to the methods described herein. The memory 310 can include one or more non-transitory computer-readable media and includes a program storage area and a data storage area. The program storage area and the data storage area can include combinations of different types of memory, as described herein. In some implementations, data described as being stored in the memory 310 may be stored in memory included in an electronic device (for example, the first computer 130) located at the first transit location source hub 105, at a remote server included in the cloud, or a combination of the foregoing.

The communication interface 315 is configured to receive input and to provide system output. The communication interface 315 obtains information and signals from, and provides information and signals to, (for example, over one or more wired and/or wireless connections) devices both internal and external to the first computer 130. The communication interface 315 may include a wireless transmitter or transceiver for wirelessly communicating over the communication network 165. Alternatively, or in addition to a wireless transmitter or transceiver, the communication interface 315 may include a port for receiving a cable, such as an Ethernet cable, for communicating over the communication network 165 or a dedicated wired connection. In some implementations, the first computer 130 communicates with other devices through one or more intermediary devices, such as routers, gateways, relays, and the like.

While not illustrated or described in detail herein, it should be understood that the second computer 145 and the third computer 160 include same or similar components and connections as described as being included in the first computer 130.

The user device 200 may be associated with a user (for example, a traveler) at the location who is not a member of security personnel at the first transit location source hub 105. For example, the user device 200 may be a laptop computer, a tablet computer, a smart phone, a smart wearable (for example, a smart watch), or the like. The user device 200 may include components and connections similar to the components and connections described as being included in the first computer 130. Additionally, the user device 200 may include an input/output device (for example, a camera, a microphone, a touchscreen, a keyboard, or the like). The electronic processor of the user device 200 may receive information about a person and/or object of interest from the input/output device and send the information to the first computer 130.

The security personnel device 205 may be associated with security personnel at the first transit location source hub 105. For example, the security personnel device 205 may be a laptop computer, a tablet computer, a smart phone, a smart wearable (for example, a smart watch), a walkie talkie, or the like. The security personnel device 205 may include components and connections similar to the components and connections described as being included in the first computer 130. Additionally, the security personnel device 205 may include an input/output device (for example, a camera, a microphone, a touchscreen, a keyboard, or the like). The electronic processor of the security personnel device 205 may receive information about a person and/or object of interest from the input/output device. The electronic processor of the security personnel device 205 may also receive, from the input/output device, information about an interaction with or responsive action taken with regard to a person and/or object of interest with a threat assessment above a first minimum threshold. The security personnel device 205 may send requests for information to the first computer 130 and receive information or alerts regarding a first person or first object from the first computer. Information or alerts from the first computer 130 may be displayed via the input/output device of the security personnel device 205.

The command center personnel device 210 may be associated with command center personnel responsible for monitoring threats and coordinating responsive actions to threats at the first transit location source hub 105. For example, the command center personnel device 210 may be a laptop computer, a tablet computer, a smart phone, a smart wearable (for example, a smart watch), a desktop computer, or the like. The command center personnel device 210 may include components and connections similar to the components and connections described as being included in the first computer 130. Additionally, the command center personnel device 210 may include an input/output device (for example, a camera, a microphone, a touchscreen, a keyboard, or the like). The electronic processor of the command center personnel device 210 may send a threat assessment to the input/output device for output (for example, display on a screen, output via a speaker). The electronic processor of the command center personnel device 210 may also receive instructions for responding (coordinating a responsive action) to a threat at the first transit location source hub 105. The electronic processor of the command center personnel device 210 may receive from the first computer 130 information requiring review. The electronic processor of the command center personnel device 210 may request information regarding a first person or a first object from the first computer 130 and/or send a request to modify information regarding a first person or a first object to the first computer 130. In some implementations, the command center personnel device 210 may request that the first computer 130 mark a threat as resolved.

In some implementations, the first camera 125 is a security camera that is mounted to a wall, ceiling, or the like of the first transit location source hub 105. In other implementations, the first camera 125 may be attached to a person (for example, attached to an item of clothing worn by security personnel) or mobile device (for example, a robot patrolling the first transit location source hub 105). In some implementations, the first camera 125 is configured to adjust its perspective by rotating or changing position. In some implementations, the first camera 125 is configured to zoom in or out to capture a detailed image or capture an image of a larger area of the first transit location source hub 105, as needed.

In some implementations, the second surveillance system 135 and the third surveillance system 150 include the same or similar components and connections as the first surveillance system 120.

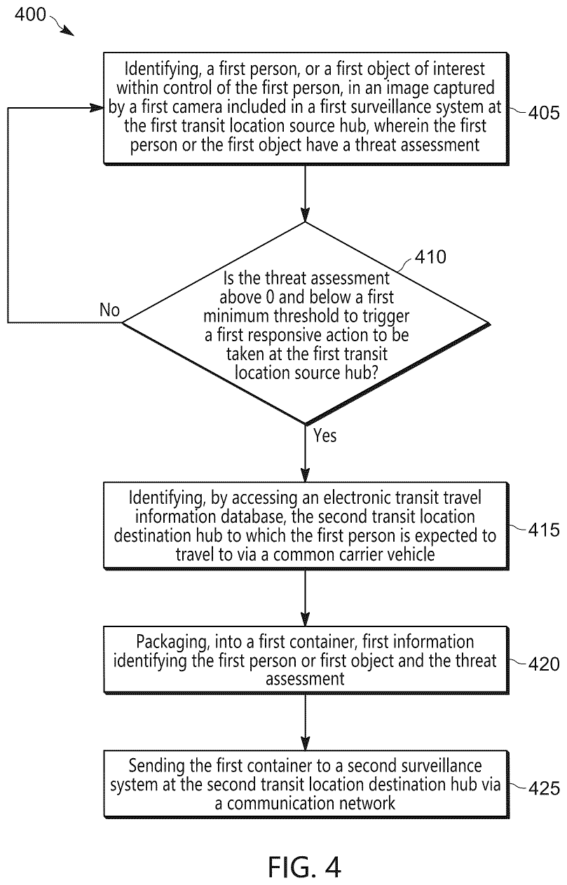

FIG. 4 is an example method 400 for collecting and sharing non-actionable information at a first transit location source hub with a second transit location destination hub. In some implementations, the method 400 begins at block 405 when the first electronic processor 300 identifies, a first person, or a first object of interest within control of the first person, in an image captured by the first camera 125 included in a first surveillance system 120 at the first transit location source hub 105, wherein the first person or the first object have a threat assessment. The threat assessment may be, for example, monitor, warning, close watch, high priority, or the like. In some implementations, the threat assessment may be based on one or more image or video data captured by the first camera, crowd sourced reports (for example, reports received from one or more user devices (for example, the user device 200)), security communication data (for example, reports received from one or more security personnel devices (for example, the security personnel device 205)), a combination of the foregoing, or the like. In some implementations, the first electronic processor 300 determines that reports, images, or the like are related to the first person or first object using facial recognition, object recognition, textual descriptions of the first person or the first object, a combination of the foregoing, and the like.

In some implementations, at block 410, the first electronic processor 300 determines whether the threat assessment is above 0 and below a first minimum threshold to trigger a first responsive action to be taken at the first transit location source hub 105. For example, a single report of suspicious behavior regarding a person of interest may not warrant security personnel taking the person of interest into custody (a responsive action), but several reports of suspicious behavior received over time as well as security footage of the person of interest engaged in suspicious behavior may meet a first minimum threshold and result in security personnel taking a person of interest into custody. In other examples, a responsive action may include questioning a person of interest, examining the belongings of a person of interest, or the like. In some examples, a threat assessment having a value between 40 to 60 on a scale of 100 may result in a responsive action. In one example, each suspicious behavior report may add 10 to 30 to a threat assessment value for a person of interest. Other ranges and values for the threat assessment are contemplated.

In some implementations, when the first electronic processor 300 determines whether the threat assessment is above the first minimum threshold, the first electronic processor 300 determines whether a first responsive action has been taken at the first transit location source hub. In some implementations, in response to determining the threat assessment is above the first minimum threshold and the first responsive action is taken at the first transit location source hub, the first electronic processor 300 does not send the first container to the second surveillance system at the second transit location destination hub. In some implementations, in response to determining the threat assessment is above the first minimum threshold and the first responsive action is taken at the first transit location source hub, the first electronic processor 300 does not perform the functionality described below in relation to blocks 415-425.

In some implementations, in response to determining the threat assessment is above the first minimum threshold and the first responsive action is not taken at the first transit location source hub, the first electronic processor 300 sends the first container to the second surveillance system 135 at the second transit location destination hub 110 (performs the functionality described below in relation to blocks 415-425).

In response to determining that the threat assessment is above 0 and below the first minimum threshold, the first electronic processor 300 may, at block 415, identify, by accessing an electronic transit travel information database, a second transit location destination hub (for example, the second transit location destination hub 110) to which the first person is expected to travel to via a common carrier vehicle (for example, the common carrier vehicle 115). For example, the first electronic processor 300 may query the electronic transit travel information database based a person of interest's name or other identifiable characteristics or a boarding location associated with a person of interest (for example, a terminal and gate at which a person of interest boards a plane, as may be detected via the first surveillance system 120).

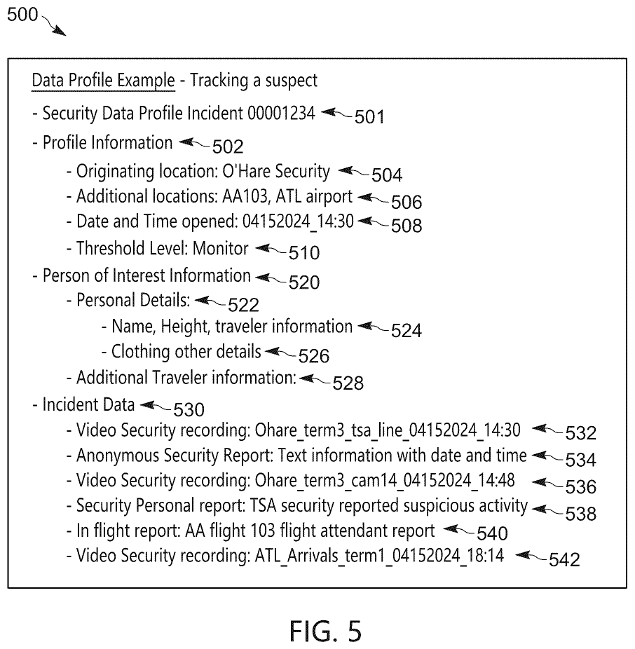

In some implementations, at block 420, the first electronic processor 300, packages, into a first container, first information identifying the first person or first object and the threat assessment. For example, the first electronic processor 300 may package or organize the first information into a data structure (for example, a map) encapsulated in a software class. The first information may include clothing worn by the first person, traveling partners, name of the first person, the first transit location source hub, the second transit location destination hub, and an identification of the common carrier vehicle (e.g., such as flight number, bus route number, etc.), the threat assessment, one or more images of the first person or first object, one or more reports or communications regarding the first person or first object, or the like. FIG. 5 provides an example of first information associated with a first person provided as a data profile 500. The FIG. 5 example for tracking a suspect includes a security data profile incident number 501 for the data profile 500. The data profile example includes profile information 502 including, but not limited to an originating location 504, additional locations 506, date and time of security incident 508, a threshold level 510, and additional profile information is contemplated. The data profile 500 of FIG. 5 also includes a person of interest information 520. This person of interest information includes personal details 522, such as name, height, traveler information 524; traveler clothing and other details 526 such as accessories being carried. Additional traveler information 528 is also contemplated. The data profile example 500 of FIG. 5 includes incident data 530. The incident data 530 includes video security recordings of the person of interest at a departing location 532, 536; anonymous security reports regarding the person of interest that include a date and a time of an incident 534, security personal reports by TSA security of suspicious activity 538, in-flight reports by a flight attendant or others 540, and video security recordings of the person of interest at an arriving location 542. Other information is also contemplated.

In some implementations, at block 425, the first electronic processor 300 sends the first container to a second surveillance system 135 at the second transit location destination hub 110 via a communication network (for example, the communication network 165).

In some implementations, a second electronic processor included in the second computer 145 at the second transit location destination hub 110 receives the first container and extracts, from the first container, the first information. The second electronic processor may use the first information to modify, relative to the first person or first object, a second minimum threshold to trigger a second responsive action at the second transit location destination hub 110. The second electronic processor may modify the second minimum threshold based on the threat assessment included in the first information. For example, the higher the threat assessment included in the first information, the lower the second electronic processor modifies the second minimum threshold to be in one instance. In other examples, when a first information has a minimum threshold of 50 out of a 100 scale, a second transit location destination hub may lower its threshold (such as 60) by 50%, among other possibilities. Other percentages are contemplated. In some implementations, instead of modifying the second minimum threshold based on the threat assessment included in the first information, the second electronic processor may increase a threat assessment associated with the first person or first object at the second transit location destination hub 110 based on the threat assessment included in the first information. For example, the higher the threat assessment included in the first information, the greater the second electronic processor determines the threat assessment associated with the first person or first object at the second transit location destination hub 110 to be when the first person or first object arrives the second transit location destination hub 110. In one example, the second electronic processor raises a threat assessment (such as 60) for the first person or object by 50% compared to the threat assessment in the first information. Other percentages are contemplated.

The second electronic processor may update the threat assessment associated with the first person or the first object based on image data received from, for example, the second camera 140, crowd sourced reports received from, for example, one or more user devices included in the second surveillance system 135, and security communication data received from, for example, one or more security personnel devices included in the second surveillance system 135, a combination of the foregoing, or the like.

In some implementations, the first electronic processor 300 identifies the common carrier vehicle 115 the first person is expected to travel via and sends the first container to a third surveillance system (for example the third surveillance system 150) at the common carrier vehicle 115.

In some implementations, a third electronic processor included in the third computer 160 of the third surveillance system 150 receives the first container from the first electronic processor 300. The third electronic processor may update the threat assessment during a journey of the common carrier vehicle 115 from the first transit location source hub 105 to the second transit location destination hub 110. The third electronic processor may update the threat assessment based on image and/or video data received from, for example, the third camera 155, crowd sourced reports received from, for example, one or more user devices included in the third surveillance system 150, and security communication data received from, for example, one or more security personnel devices included in the third surveillance system 150, a combination of the foregoing, or the like. For example, the third camera 155 may capture an image of the first person behaving in a suspicious manner (for example, grabbing the arm of a woman who appears frightened) and based on the image, the third electronic processor may increase the threat assessment.

The third electronic processor may package, into a second container, second information identifying the first person or first object and the updated threat assessment and send the second container to the second surveillance system 135 at the second transit location destination hub 110 when, for example, the common carrier vehicle 115 arrives at the second transit location destination hub 110. The second computer 145 at the second transit location destination hub 110 may recognize that the first information or the second information relate to the first person or first object and link or combine the first information with the second information in memory. In some implementations, the second computer 145 may combine or link the first information and second information in response to receiving a request from a command center personnel device included in the second surveillance system 135 and may modify its threshold in a same or similar way to that already noted above.

In some implementations, the first electronic processor 300 determines a bandwidth of the communication network 165 prior to sending the first container. Based on a bandwidth of the communication network 165, an amount of data to be transmitted via the communication network 165, and a time period in which the data is to be transmitted via the communication network 165, the first electronic processor 300 may determine whether to prioritize the data sent via the communication network 165. In some implementations, the first electronic processor 300 prioritizes the data by sending containers via the communication network 165 in an order based on priority. For example, the first electronic processor 300 may determine a first priority associated with the first container based on 1) a departure time or arrival time associated with the common carrier vehicle 115, 2) the threat assessment, or both 1) and 2). In some implementations, the first electronic processor 300 also utilizes a size of a first container, a type of first information, a combination of the foregoing, and the like to determine the first priority associated with the first container. The first electronic processor 300 may determine when to send the first container via the communication network 165 based on the first priority associated with the first container compared to a priority associated with another container. For example, when the first priority associated with the first container is higher than a priority associated with another container, the first electronic processor 300 may transmit the first container via the communication network 165 before transmitting the other container. In one example, a first container having a medium priority at 20 points arrives in 1 hour (20 points or score). A second container having a low threat of 40 points (relatively higher) arrives in 1.5 hours (30 points, relatively higher). The first electronic processor 300 then compares the priorities and times associated with the containers and the lower number of points or score is sent first, such as a first container having a value of 20 as compared to a second container having a value of 30.

In some implementations, the first electronic processor 300 prioritizes the data by modifying the first information included in the first container. In some implementations, the first electronic processor 300 modifies the first container to include high value first information requiring a relatively low amount of bandwidth to transmit, for example, less than 500 megabits per second (Mbps), less than 100 Mbps, or less than 50 Mbps. When bandwidth is limited between the first and second hubs, the first container may include only a textual description of the first person and/or first object and personal information associated with the first person. When more bandwidth is available, the first container may include high value still shots from captured video (for example, the face of the first person, an activity performed by the first person that influenced the threat assessment), written reports regarding the first person or the first object, low resolution video, a combination of the foregoing, or the like. When more bandwidth is available (for example, 50 Mbps or more, preferably 100 Mbps or more, or even more preferably 500 Mbps or more), the first container may include high resolution video data. First information that is not included in the first container sent to the second surveillance system 135 may be packaged and sent to the second surveillance system 135 later when the available bandwidth of the communication network 165 is greater. In some implementations, the first electronic processor 300 sends first information that is not included in the first container sent to the second surveillance system 135, only when a responsive request for the first information is received from the second computer 145.

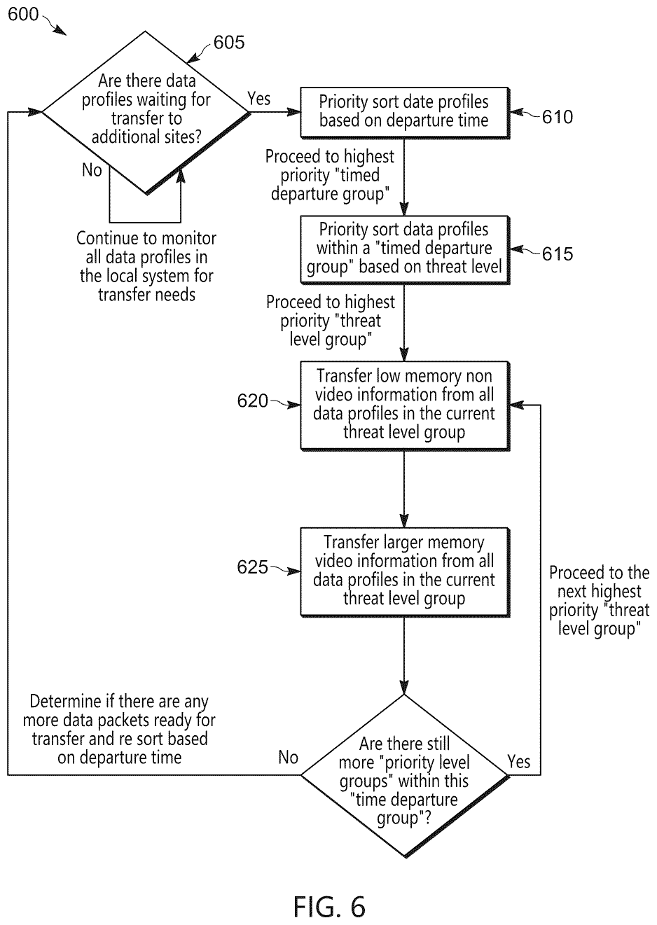

In some implementations, the first electronic processor 300 prioritizes the data by sending containers via the communication network 165 in an order based on priority and modifying the first information included in the first container. FIG. 6 provides an example flowchart of a method 600 for prioritizing data by sending containers via a communication network in an order based on priority and modifying the first information included in the first container. In some implementations, the method 600 begins at block 605, when the first electronic processor 300 determines whether one or more data profiles need to be sent to a destination (for example, the second surveillance system 135 at the second transit location destination hub 110 or the third surveillance system 150 at the common carrier vehicle 115). A data profile refers to information (including a threat assessment) regarding a first person, or a first object of interest within control of the first person that may be packaged into a container and sent via the communication network 165. When one or more data profiles need to be sent to a destination, at block 610, the first electronic processor 300 sorts data profiles based on a departure time associated with a common carrier vehicle that the first person is scheduled to travel via. For example, data profiles may be grouped into data profiles that need to be transmitted in the next ten minutes, the next 30 minutes, etc. The data profiles associated with the most imminent departure times may be given the highest priority.

In some implementations, at block 615, the first electronic processor 300 sorts or groups the data profiles included in the highest priority group determined at block 610 based on the threat assessment included in the data profile. For example, data profiles associated with the highest or most severe threat assessment may be included in the highest priority group determined at block 615. In some implementations, at block 620, for each data profile included in the highest unsent priority group determined at block 615, the first electronic processor 300 packages low memory, non-video information into a container and transmits or sends the container to the destination. At block 625, for each data profile included in the highest unsent priority group determined at block 615, the first electronic processor 300 may package high memory video information into a container and transmit or sends the container to the destination. The first electronic processor 300 may repeat the functionality described in relation to blocks 615 and 620 for each group of data profiles determined at block 615.

In some implementations, in order to maximize bandwidth efficiency, video data included in a container may be compressed. Due to the importance of video quality, a lossless compression method may be utilized to generate a compressed video. For example, a video may be compressed into a VP9 or AV1 format video, among other possibilities.

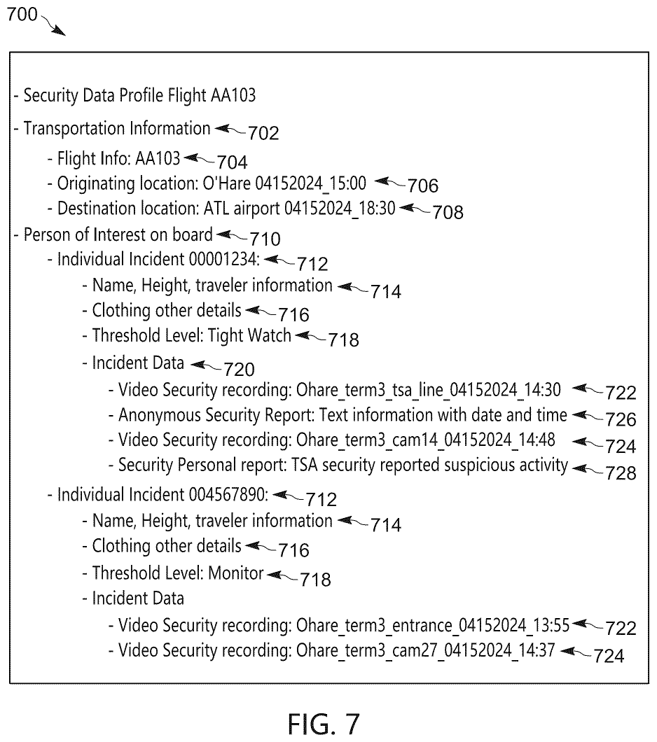

In some implementations, an electronic processor included in a computer in a surveillance system may receive, from a security personnel device or a command central personnel device, a request for information regarding persons and/or objects of interest traveling on a common carrier vehicle. In response, the electronic processor may return for information regarding persons and/or objects of interest traveling on a common carrier vehicle. FIG. 7 provides an example of information regarding persons and/or objects of interest traveling on a common carrier vehicle (in FIG. 7, flight AA103) that an electronic processor may send to a security personnel device or a command central personnel device. The security data profile 700 shown in FIG. 7 for a particular flight includes transportation information 702 including, but not limited to flight information 704, originating location and time 706, and destination location and projected arrival time 708. The security data profile 700 includes, for each person of interest 710 on board a flight an individual incident identifier 712, and name, height, and traveler information 714 for a person of interest. Further, the individual incident 712 includes clothing and other details 716, a threshold level 718, and incident data 720. The incident data 720 can include video security recordings 722, 724; anonymous security reports 726, and security personal reports 728. Other information and data are also contemplated. In other examples more or less data is provided.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded, electronically encoded audio, etc., and cannot dynamically adjust data packages transmitted over a network based on network bandwidth, among other features and functions set forth herein).

In the foregoing specification, specific embodiments, examples, aspects, and features have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments, examples, aspects, and features may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, one or more of the embodiments, examples, aspects, and features presented herein can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples and embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system for collecting and sharing non-actionable information at a first transit location source hub with a second transit location destination hub, the system comprising:
a first surveillance system at the first transit location source hub, the first surveillance system including:
a first camera; and
a first computer including a first electronic processor, the first electronic processor programmed to:
identify, a first person, or a first object of interest within control of the first person, in an image captured by the first camera, wherein the first person or the first object have a threat assessment; and
in response to the threat assessment being above 0 and below a first minimum threshold to trigger a first responsive action to be taken at the first transit location source hub,
identify, by accessing an electronic transit travel information database, the second transit location destination hub to which the first person is expected to travel to via a common carrier vehicle;
package, into a first container, first information identifying the first person or first object and the threat assessment; and
send the first container to a second surveillance system at the second transit location destination hub via a communication network.

2. The system according to claim 1, wherein the second surveillance system includes:
a second camera; and
a second computer including a second electronic processor, the second electronic processor programmed to:
receive the first container;
extract, from the first container, the first information; and
use the first information to modify, relative to the first person or first object, a second minimum threshold to trigger a second responsive action at the second transit location destination hub.

3. The system according to claim 1, wherein the first electronic processor is further programmed to:
identify the common carrier vehicle the first person is expected to travel via; and
send the first container to a third surveillance system at the common carrier vehicle.

4. The system according to claim 3, wherein the third surveillance system includes a third electronic processor, the third electronic processor programmed to:
receive the first container;
update the threat assessment during a journey of the common carrier vehicle from the first transit location source hub to the second transit location destination hub;
package, in to a second container, second information identifying the first person or first object and the updated threat assessment; and
send the second container to the second surveillance system at the second transit location destination hub.

5. The system according to claim 1, wherein the threat assessment is determined using at least one selected from the group consisting of image data, crowd sourced reports, and security communication data.

6. The system according to claim 1, wherein the first electronic processor is further programmed to:
determine whether the threat assessment is above the first minimum threshold and the first responsive action is taken at the first transit location source hub; and
in response to determining the threat assessment is above the first minimum threshold and the first responsive action is taken at the first transit location source hub, do not send the first container to the second surveillance system at the second transit location destination hub.

7. The system according to claim 1, wherein the first electronic processor is further programmed to:
determine whether the threat assessment is above the first minimum threshold and the first responsive action is taken at the first transit location source hub; and
in response to determining the threat assessment is above the first minimum threshold and the first responsive action is not taken at the first transit location source hub, send the first container to the second surveillance system at the second transit location destination hub.

8. The system according to claim 1, wherein the first information includes the first transit location source hub, the second transit location destination hub, and the common carrier vehicle.

9. The system according to claim 1, wherein the first electronic processor is further programmed to:
determine a first priority associated with the first container based on 1) a departure time or an arrival time associated with the common carrier vehicle, 2) the threat assessment, or both 1) and 2); and
determine when to send the first container to the second surveillance system at the second transit location destination hub via the communication network based on the first priority associated with the first container compared to a priority associated with another container.

10. The system according to claim 1, wherein the first electronic processor is further programmed to:
determine whether to prioritize data based on a bandwidth of the communication network, an amount of data to be transmitted via the communication network, and a time period in which the data is to be transmitted via the communication network, wherein prioritizing data includes modifying the first container to include high value first information requiring 50 Mbps or less bandwidth to transmit.

11. A method for collecting and sharing non-actionable information at a first transit location source hub with a second transit location destination hub, the method comprising:
identifying, a first person, or a first object of interest within control of the first person, in an image captured by a first camera included in a first surveillance system at the first transit location source hub, wherein the first person or the first object have a threat assessment; and
in response to the threat assessment being above 0 and below a first minimum threshold to trigger a first responsive action to be taken at the first transit location source hub,
identifying, by accessing an electronic transit travel information database, the second transit location destination hub to which the first person is expected to travel to via a common carrier vehicle;
packaging, into a first container, first information identifying the first person or first object and the threat assessment; and
sending the first container to a second surveillance system at the second transit location destination hub via a communication network.

12. The method according to claim 11, the method further comprising:
receiving, with second surveillance system, the first container;
extracting, from the first container, the first information; and
using the first information to modify, relative to the first person or first object, a second minimum threshold to trigger a second responsive action at the second transit location destination hub.

13. The method according to claim 11, the method further comprising:
identifying the common carrier vehicle the first person is expected to travel via; and
sending the first container to a third surveillance system at the common carrier vehicle.

14. The method according to claim 13, wherein the third surveillance system includes a third electronic processor, the third electronic processor programmed to:
receiving, the third surveillance system, the first container;
updating the threat assessment during a journey of the common carrier vehicle from the first transit location source hub to the second transit location destination hub;
packaging, in to a second container, second information identifying the first person or first object and the updated threat assessment; and
sending the second container to the second surveillance system at the second transit location destination hub.

15. The method according to claim 11, wherein the threat assessment is determined using at least one selected from the group consisting of image data, crowd sourced reports, and security communication data.

16. The method according to claim 11, the method further comprising:
determining whether the threat assessment is above the first minimum threshold and the first responsive action is taken at the first transit location source hub; and
in response to determining the threat assessment is above the first minimum threshold and the first responsive action is taken at the first transit location source hub, not sending the first container to the second surveillance system at the second transit location destination hub.

17. The method according to claim 11, the method further comprising:
determining whether the threat assessment is above the first minimum threshold and the first responsive action is taken at the first transit location source hub; and
in response to determining the threat assessment is above the first minimum threshold and the first responsive action is not taken at the first transit location source hub, sending the first container to the second surveillance system at the second transit location destination hub.

18. The method according to claim 11, wherein the first information includes the first transit location source hub, the second transit location destination hub, and the common carrier vehicle.

19. The method according to claim 11, the method further comprising:
determining a first priority associated with the first container based on 1) a departure time or an arrival time associated with the common carrier vehicle, 2) the threat assessment, or both 1) and 2); and
determining when to send the first container to the second surveillance system at the second transit location destination hub via the communication network based on the first priority associated with the first container compared to a priority associated with another container.

20. The method according to claim 11, the method further comprising:
determining whether to prioritize data based on a bandwidth of the communication network, an amount of data to be transmitted via the communication network, and a time period in which the data is to be transmitted via the communication network, wherein prioritizing data includes modifying the first container to include high value first information requiring 50 Mbps or less bandwidth to transmit.
